(19) United States
(12) Patent Application Publication
(10) Pub. No.: US 2004/0073604 A1
(43) Pub. Date: Apr. 15, 2004

(54) Cache control method of proxy server with white list

(76) Inventors: Kazuhiro Moriya, Kawasaki-Shi (JP); Hironobu Sugimoto, Matsudo-Shi (JP)

Correspondence Address: LADAS & PARRY, Suite 2100, 5670 Wilshire Boulevard, Los Angeles, CA, 90036-5679, US

(21) Appl. No.: 10/270,038

(22) Filed: Oct. 11, 2002

(51) Int. Cl. G06F 15/16

(52) U.S. Cl. 709/202

(57) ABSTRACT

A cache control method is provided which allows a cache state in a proxy server and a client use state to be synchronized and can improve a cache-efficiency regardless of time zones. A cache control method of a proxy server for relaying data between one or more clients connected to one communication network and a data server connected to the other communication network with a white list, includes the steps of determining whether or not a URL requested by a user of the client is registered in a white list, and processing data at the URL to be cached if the URL is registered in the white list.

### BACKGROUND OF THE INVENTION

1. Field of the Invention

The present invention relates to a data cache method in a server for relaying data and, more particularly, to a cache control method, which allows a client use state and a cache state to be synchronized.

2. Description of the Related Art

Conventionally, some servers for relaying accesses to the Internet include a data cache function. A so-called cache server stores a copy of data managed by a server such as a Web server and provides data fast instead of a server accessed by a user. For example, a proxy server connected between a local area network (LAN) in an organization such as a company and a communication network such as the Internet stores a Web page referred by someone in the organization for a certain period of time. When the other users access the same page, the Web page in the cache server is sent.

The server having the cache function conventionally caches all data. Once an amount of stored data excesses the maximum size of the cache area of a recording medium, subsequent data is written over the data having stored in the cache area unconditionally. As a result, the overwritten data is replaced by other data unconditionally. The same is true in a cache method using an index. All of the cached data to be relayed are replaced by other data unconditionally if they have the same index even with different contents.

As described above, a cache server such as a proxy server for relaying data caches all of data. Therefore, there is a problem in that the cache area is occupied by data, which is seldom used, and data is overwritten when the cache area is full. According to a cache method using a hit rate, the cache efficiency may be improved. However, the hit rate varies in time axis. As a result, the cache efficiency depends on a time zone and/or an access frequency of same data.

### SUMMARY OF THE INVENTION

The present invention was made in view of these problems. It is an object of the present invention to provide a cache control method, which allows a cache state in a proxy server and a client use state to be synchronized and which can improve a cache efficiency regardless of time zones.

According to one aspect of the present invention, there is provided a cache control method of a proxy server for relaying data between one or more clients to one communication network and a data server connected to the other communication network with a white list, including the steps of determining whether or not a URL requested by a user of the client is registered in a white list, and processing data at the URL to be cached if the URL is registered in the white list.

The white list may be a list in which a useful URL used by the user frequently is registered or a list registered and managed by specific software for a special purpose; and the white list includes one or both of a list managed by a Web browser and the list managed by specific software for a special purpose. The method may further include the steps of, for controlling the data caching, providing the white list in the client, performing the determination by the client, setting and sending a cache ID indicating whether the data needs to be cached or not by the client, and identifying whether the data is to be cached or not based on the cache ID set in the HTTP request. Preferably, the method further includes the steps of, for controlling the data caching, storing the white list in a memory medium in the proxy server and then performing the determination by the proxy server. The communication network to which the clients are connected may be a LAN or an intranet to which the data server is connected. The communication network to which the data server is connected may be a LAN, an intranet or the Internet. In this way, the method can be implemented more effectively.

### BRIEF DESCRIPTION OF THE DRAWINGS

FIG. 1 is a schematic diagram showing an example of an entire construction of a proxy server system according to the present invention;

FIG. 2 is a diagram for explaining an example of an interface between a client and a proxy server; and

FIG. 3 is a flowchart for explaining a cache control method using a white list according to the present invention.

### DESCRIPTION OF THE PREFERRED EMBODIMENTS

In order to access a Web site on the Internet, inputting an address of the Web site takes time. Thus, a Uniform Resource Locator (URL), which is used by a user frequently, and/or useful URL may be registered with a menu list for a browser, such as “Favorite” of Internet Explorer by Microsoft and “Bookmark” of Netscape Navigator by Netscape Communications. Then, a URL may be selected from the menu list to access the page generally. Recently, many kinds of specific software have been developed and been implemented for supporting viewing and/or exchanging useful data by using a communication network such as a LAN and the Internet for a specific group. The support software includes those for teaching in schools and for a medical information network. The specific software for special purposes may have a function for accessing a proper dataserver by using a list with which URL's of specific parties are registered to distribute useful data to corresponding client and/or for having a conversation by exchanging data between clients within a specific group easily.

According to the present invention, a list in which advantageous (useful) URL used by a user and/or members in a specific group frequently are registered or a list managed by specific software, which is used for a specific purpose, such as the menu list for the browser and the list for the specific software as described above, is used for cache control (The list is called “white list”). Thus, a cache state of a proxy server and a client use state can be synchronized. In other words, according to the present invention, a white list is used in addition to the conventional method as a criterion for the data cache. As a result, advantageous data used by a user and/or members in a specific group frequently is cached for improving the hit rate. In addition, the use of a white list can prevent a cache area from being occupied by data only used by a specific person and/or prevent capacity of a cache area from lacking. In a preferred embodiment of the present invention, a cache control function is built-in by using plug-in (add-in software) so as to connect with a browser and/or specific software as described above. Thus, when an access to a URL registered in a white list is requested, data is cached automatically.

A preferred embodiment of the present invention will be described below in detail with respect to drawings.

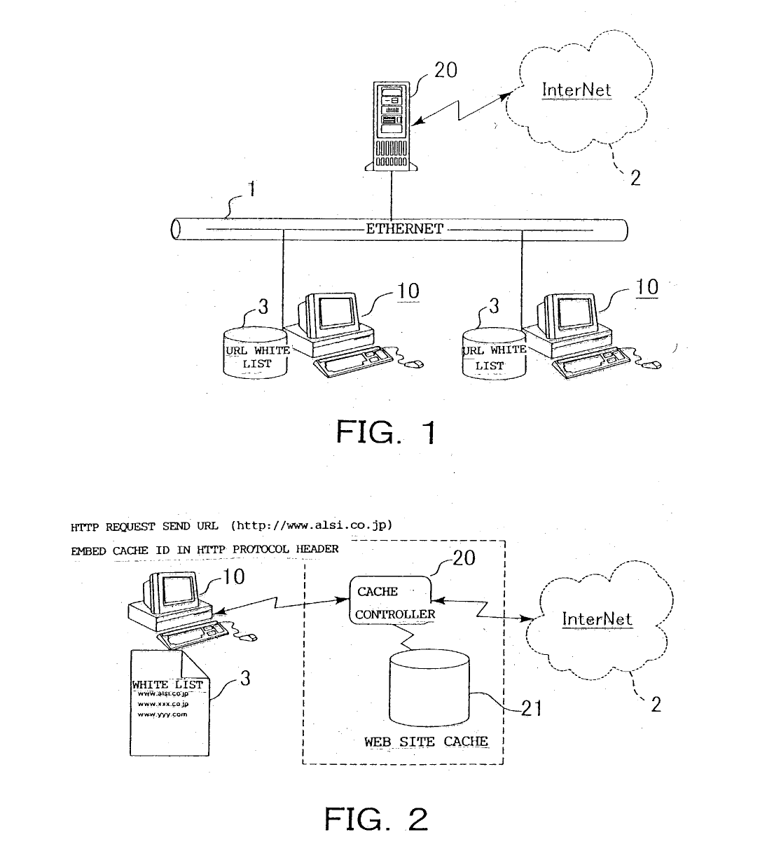

FIG. 1 is a schematic diagram showing one example of an entire construction of a proxy server system according to the present invention. As shown in FIG. 1, in order to allow multiple clients to connect to the Internet, for example, each client 10 is connected to a LAN 1 such as Ethernet and a proxy server 20 is connected between the LAN 1 and the Internet 2. Thus, data is exchanged between a dataserver 30, such as a Web server, and each of clients 10 through the proxy server 20 having a security function and/or a cache function. In this embodiment, a “white list” 3 in which useful URL used by a user or members in a specific group frequently are registered, is provided for each of the clients 10. Thus, in the proxy server 20 for relaying data, the URL data registered in the white list 3 can be controlled to be cached. The computer network to which the clients 10 are connected may be a communication network such as a LAN and an intranet for clients in a specific group. The communication network may be an intracorporate network, a network at home, a network connecting personal computers between a teacher and students, and a medical information network. These networks frequently use same URL. Therefore, the white list can be used for cache control more effectively.

FIG. 2 shows an example of an interface used for cache control between the client 10 and the proxy server 20. In a system configuration where the white list 3 is held by the client 10, a setting area for an identifier (called cache ID hereinafter) for identifying whether the data is cached or not is provided in a header of a communication protocol, for example. The shown interface notifies to the proxy server 20 whether the data is required to cache based on the cache ID. For example, when Hypertext Transfer Protocol (HTTP) is used as a communication protocol, the cache ID setting area is provided in an extension header of the HTTP protocol header. Then, with reference to the white list 3, a cache ID setting function for setting a cache ID in the area of the extension header is provided to the client 10. Then, an HTTP request in which a cache ID is set is sent from the client 10 to the proxy server 20. Thus, the proxy server 20 is instructed to cache or not to cache data at the URL.

The cache ID setting function may be implemented by building plug-in (add-in software), for example, in software (such as the browser and specific software) for sending an HTTP request. On the other hand, the proxy server 20 determines whether or not data at an accessed URL is cached or not based on a cache ID in a header of a communication protocol. If a cache ID is set, the proxy server 20 processes data at a given URL as to be cached. These steps (functions) by the proxy server 20 can be built in a cache control portion for data cache control.

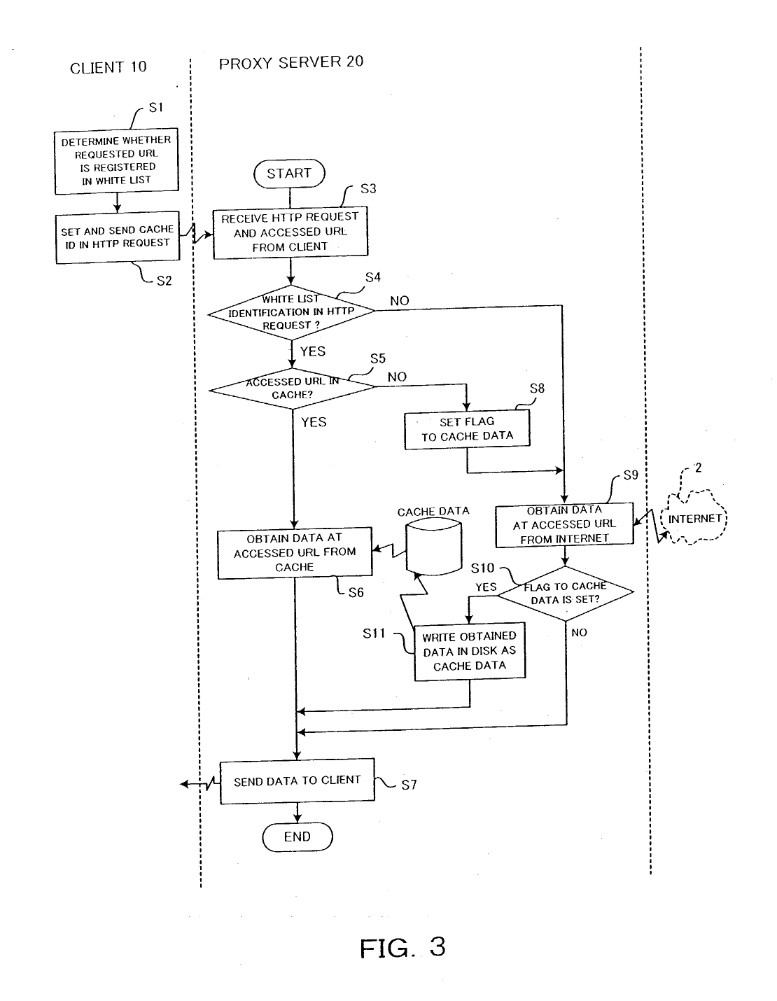

An example of an operation by the proxy server according to the cache control method with a white list of the present invention in this construction will be described with reference to a flowchart in FIG. 3. The cache control by the proxy server after determining to cache is the same as the conventional control method relating to a hit rate, an update date, a memory time in a cache, a data size, a type of cache medium and so on. Therefore, the description will be omitted here.

When a URL of accessed data (called “accessed URL” hereinafter) is instructed by a user or specific software, the client 10 determines whether the accessed URL is registered in a white list (step S1). If the accessed URL is registered in the white list, a cache ID indicating to cache (or caching is needed or not) is set in a protocol header of an HTTP request. Then, access request (the HTTP request and the accessed URL) for obtaining data is sent (step S2). The proxy server 20 receives the access request and checks whether the protocol header of the HTTP request has the cache ID or not (steps S3 and S4). If the protocol header has the cache ID, the proxy server 20 determines whether the cache has the data at the accessed URL or not (step S5).

The cache has the data at the accessed URL, the data is obtained from the cache (step S6). Then, the data is sent to the requesting client 10 (step S7). On the other hand, at step S5, if the cache does not have the data at the accessed URL, a flag indicating the data is a cache target is set (step S8). Then, the data at the accessed URL is obtained from the Internet (step S9). At step S4, if the protocol header does not have the cache ID, the processing goes to step S9. Then, data at the accessed URL is obtained from the Internet. Then, it is determined whether or not the flag for the cache target is set (step S10). If the flag is not set, the processing goes to step S7. There, the data obtained from the Internet is sent to the requesting client 10. Then, the processing for the request for obtaining the data ends.

On the other hand, at step S10, if the flag for caching data is set, in other words, when the access request includes the cache ID but the cache does not have the accessed URL, data obtained from the Internet is written in a cache memory medium 21 such as a memory and a disk medium (step S11). Then, the processing goes to step S6, where the data at the accessed URL is obtained from the cache. The data is sent to the requesting client 10, and the processing for the request for obtaining the data ends.

Next, another embodiment of the cache control method with a white list will be described.

While the case where a white list is provided to a client has been described in the above-described embodiment, the white list may be provided to the proxy server. Alternatively, the white list may be provided both of the client and proxy server. Then, data may be a cache target if an accessed URL is registered in one of the white lists. A URL registered in the white list may be handled as a cache target selectively in accordance with user's instruction. When the present invention is applied to a client-server system in an organization such as a school or a company, the white list is desirably provided as shared data of clients rather than being provided and being managed by each client. However, multiple white lists may be provided to a server as shared data. A white list may be prepared for registration for each application and/or for each group such as a division.

A method for controlling data caching with reference to a white list provided in a proxy server will be described below.

In the above-described embodiment, in which a white list is provided in the client 10, a cache ID is set in a header of a communication protocol by the client 10. Then, the proxy server 20 is instructed to cache or not based on the cache ID. In this embodiment in which a white list is provided in the proxy server 20, a special function does not have to be added to software such as a browser in the client 10. Software available on the market can be used directly. An operational example in the proxy server 20 will be described. The cache control is the same as the processing at steps S5 to S11 in FIG. 3. Thus, the description will be omitted here.

When received an access request from a client, a proxy server determines whether a requested URL (address of accessed data) is registered in a white list or not. The subsequent processing is the same as the above-described embodiment except that this determination processing is added to the processing by the proxy server. In other words, if the accessed URL is registered in the white list, the data at the URL is controlled to cache. If the access URL is not registered in the white list, data at the accessed URL is obtained from the Internet and is sent to the requesting client. In this way, caching data at a given URL may be controlled by using a white list provided in a proxy server.

In this embodiment, a proxy server is used as an example of a server according to the cache control method of the present invention. However, the server is not limited to a proxy server but may be a server, such as a gateway server and a node computer, for relaying data between one or mode clients connected to one communication network and a data server connected to the other communication network. The requested data server is not limited to a Web server on the Internet but may be a data server connected to a communication network (such as a LAN, an intranet and an extranet) except for the Internet.

According to the present invention, a white list is referenced on which a useful URL used by a user or members of a specific group using a client is registered and the URL registered in the white list is processed to be cached. Therefore, a cache state and a client use state can be synchronized. Thus, the cache efficiency can be improved regardless of time zones. In addition, the cache area may be hardly occupied by seldom-used data, and data may be hardly overwritten because the cache area is full.

What is claimed is:

1. A cache control method of a proxy server for relaying data between one or more clients to one communication network and a data server connected to the other communication network with a white list, comprising the steps of:
determining whether or not a URL requested by a user of the client is registered in a white list; and
processing data at the URL to be cached if the URL is registered in the white list.

2. A cache control method of a proxy server with a white list according to claim 1, wherein the white list is a list in which a useful URL used by the user or members of a specific group frequently is registered or a list registered and managed by specific software for a special purpose; and the white list includes one or both of a list managed by a Web browser and the list managed by specific software for a special purpose.

3. A cache control method of a proxy server with a white list according to claim 1, further comprising the steps of, for controlling the data caching:
providing the white list in the client;
performing the determination by the client;
setting and sending a cache ID indicating whether the data needs to be cached or not by the client in the HTTP request; and
identifying whether the data is to be cached or not based on the cache ID set in the HTTP request.

4. A cache control method of a proxy server with a white list according to claim 1, further comprising the steps of, for controlling the data caching:
storing the white list in a memory medium in the proxy server and then performing the determination by the proxy server.

5. A cache control method of a proxy server with a white list according to claim 1, wherein the communication network to which the clients are connected is a LAN or an intranet to which the data server is connected; and the communication network to which the data server is connected is a LAN, an intranet or the Internet.
